(19) United States
(12) Patent Application Publication
(10) Pub. No.: US 2022/0105779 A1
(43) Pub. Date: Apr. 7, 2022

(54) COOLING DEVICE FOR A VEHICLE ELECTRONIC INSTRUMENT, CONTROL METHOD OF A COOLING DEVICE FOR VEHICLE ELECTRONIC INSTRUMENTS AND PROGRAM STORAGE MEDIUM

(71) Applicant: TOYOTA JIDOSHA KABUSHIKI KAISHA, Toyota-shi (JP)

(72) Inventor: Hiromi YAMANASHI, Toyota-shi (JP)

(73) Assignee: TOYOTA JIDOSHA KABUSHIKI KAISHA, Toyota-shi (JP)

(21) Appl. No.: 17/480,343

(22) Filed: Sep. 21, 2021

(30) Foreign Application Priority Data
Oct. 6, 2020 (JP) 2020-169392

(51) Int. Cl. B60H 1/00

(52) U.S. Cl. CPC B60H 1/00271; B60H 1/00564; B60H 2001/00942; B60H 2001/003; B60H 1/00885

(57) ABSTRACT

A cooling device for a vehicle electronic instrument, includes: a rear air-conditioning section that is provided in a rear trunk at a vehicle rear portion, that is configured to adjust a temperature of air, and that supplies air to a vehicle cabin interior; and an electronic instrument cooling duct that configures a cooling path in the rear air-conditioning section and through which passes cooling air, one or more electronic instruments being disposed in the cooling path.

### CROSS-REFERENCE TO RELATED APPLICATION

This application is based on and claims priority under 35 USC 119 from Japanese Patent Application No. 2020-169392 filed on Oct. 6, 2020, the disclosure of which is incorporated by reference herein.

### BACKGROUND

### Technical Field

The present disclosure relates to a cooling device for a vehicle electronic instrument, a method of controlling a cooling device for a vehicle electronic instrument, and a storage medium on which is stored a program for controlling a cooling device for a vehicle electronic instrument.

### Related Art

A structure that enables temperature adjustment to be performed for electronic devices located inside a pillar or in the vicinity of a dashboard is disclosed in Japanese Patent Application Laid-Open (JP-A) No. 2013-216313. In the structure described in this publication, the temperature of electronic devices located inside a pillar or in the vicinity of a dashboard is adjusted by supplying an airflow whose temperature has been adjusted by an air-conditioning system to the electronic devices via a housing.

However, in a case in which the shape and size of electronic devices such as electronic instruments have increased due to the increasing complexity of vehicle control, there may be situations in which it is not possible for these electronic instruments to be disposed inside a pillar or in the vicinity of the dashboard. In this case, in the structure described in JP-A No. 2013-216313, it is difficult for adequate cooling of electronic instruments to be achieved.

### SUMMARY

The present disclosure has been conceived in view of the above-described circumstances, and provides a cooling device for a vehicle electronic instrument, a method of controlling a cooling device for a vehicle electronic instrument, and a storage medium storing a controlling program for a cooling device for a vehicle electronic instrument that make it possible to cool electronic instruments even in a case in which it is not possible for these electronic instruments to be disposed inside a pillar or in the vicinity of the dashboard.

A first aspect of the present disclosure is a cooling device for a vehicle electronic instrument, the cooling device including: a rear air-conditioning section that is provided in a rear trunk at a vehicle rear portion, that is configured to adjust a temperature of air, and that supplies air to a vehicle cabin interior; and an electronic instrument cooling duct that configures a cooling path in the rear air-conditioning section and through which passes cooling air, one or more electronic instruments being disposed in the cooling path.

According to the cooling device of the first aspect, when a rear air-conditioning section is operated, air is supplied from the rear air-conditioning section to the vehicle cabin interior. The airflow from the rear air-conditioning section flows through an electronic instrument cooling duct towards the electronic instrument. Electronic instruments provided along the rear air-conditioning section are cooled by the airflow flowing through the electronic instrument cooling duct.

In the first aspect, the electronic instrument may include: a first electronic instrument that is disposed in the electronic instrument cooling duct and includes one or more elements therein; and a second electronic instrument that is disposed at a downstream side in an air supply direction from the first electronic instrument and includes one or more elements having a higher heat resistance temperature than that of the one or more elements inside the first electronic instrument.

According to the above-described structure, a first electronic instrument is disposed within the electronic instrument cooling duct at an upstream side in the airflow direction from a second electronic instrument. Because of this, the airflow within the electronic instrument cooling duct may be supplied to the first electronic instrument side before it is supplied to the second electronic instrument. As a result, preference may be given to cooling the first electronic instrument, which includes elements whose heat resistance temperature is lower than those in the second electronic instrument.

In the above-described structure, the electronic instrument may include: a first ECU that processes information on a vehicle periphery; and a second ECU that is able to perform mutual communication with the first ECU and that controls driving of the vehicle, and if one of the first ECU or the second ECU fails, the other of the first ECU or the second ECU may continue to control the driving of the vehicle for at least a predetermined period of time.

According to the above-described structure, preference may be given to cooling the first ECU, which includes elements whose heat resistance temperature is lower than those in the second ECU. Because of this, it is possible to inhibit failures caused by the first ECU overheating, and it is possible to appropriately cool the second ECU, which includes elements whose heat resistance temperature is higher than those in the first ECU. Moreover, even if one of the first ECU or the second ECU were to fail, the other one of the first ECU or the second ECU is able to continue to control the driving of the vehicle for at least a predetermined period of time.

The first aspect may further include a temperature sensor that measures a temperature of the electronic instruments; and a processor that is configured to control the rear air-conditioning section based on a temperature measured by the temperature sensor.

According to the above-described structure, the rear air-conditioning section is controlled based on a temperature measured by the temperature sensor. Because of this, the electronic devices may be appropriately cooled in accordance with the temperature of the electronic devices.

In the above-described structure, the processor may be configured to continue operation of the rear air-conditioning section after an operation to stop the rear air-conditioning section has been performed by a vehicle occupant.

According to the above-described structure, an operation of the rear air-conditioning section is continued after an action to stop an operation of the rear air-conditioning section has been performed by a vehicle occupant. Because of this, the electronic instruments may still be cooled regardless of whether or not an action to stop an operation of the rear air-conditioning section has been performed by a vehicle occupant.

In the above-described structure, the processor may be configured to continue the operation of the rear air-conditioning section at a lower output than the output before the operation to stop the rear air-conditioning section has been performed by a vehicle occupant.

According to the above-described structure, the operation of the rear air-conditioning section is continued at lower output than the output before the action to stop the operation of the rear air-conditioning section has been performed by a vehicle occupant. Because of this, it is possible to reduce a level of noise caused by the operation of the rear air-conditioning section after the action to stop the operation of the rear air-conditioning section has been performed by a vehicle occupant.

In the first aspect, the electronic instrument may include an electronic instrument main body and a heat discharge portion that is formed integrally with the electronic instrument main body, and the electronic instrument main body may be disposed outside of the electronic instrument cooling duct, while the heat discharge portion is disposed inside the electronic instrument cooling duct.

According to the above-described structure, only the heat discharge portion of the electronic instrument is disposed inside the electronic instrument cooling duct. Because of this, compared with a case in which the entire electronic instrument is disposed inside the electronic instrument cooling duct, it is possible to more effectively inhibit any increase in the size of the electronic instrument cooling duct.

In the first aspect, the rear air-conditioning section may include: a main flow portion through which flows the airflow towards the vehicle cabin interior, and from which the electronic instrument cooling duct branches off; and a valve that is provided at a boundary between the main flow portion and the electronic instrument cooling duct, and that selectively blocks or allows passage of the airflow from the main flow portion side towards the electronic instrument cooling duct side.

According to the above-described structure, there is provided a valve that selectively blocks or allows the airflow from the main flow portion side towards the electronic instrument cooling duct side. Because of this, in a case in which it is not necessary to cool electronic instruments using the rear air-conditioning section, it is possible to inhibit a decrease in the flow rate of the airflow inside the main flow portion.

The first aspect may further include a bracket that supports the electronic instrument cooling duct and the electronic instruments at a vehicle body.

According to the above-described structure, the electronic instrument cooling duct and the electronic instruments are supported on a vehicle body via the same bracket. Because of this, compared with a structure in which the electronic instrument cooling duct and the electronic instruments are supported on a vehicle body by mutually different brackets, it is possible to reduce disparities between the positions of the electronic instrument cooling duct and the electronic instruments.

In the first aspect, the rear air-conditioning section and the electronic instrument may be disposed within a rear trunk that is provided at a vehicle rear side of the vehicle cabin interior and into which luggage is able to be loaded from the vehicle rear side, and the electronic instrument may be disposed at the vehicle rear side relative to the rear air-conditioning section.

According to the above-described structure, the electronic instruments are disposed at the vehicle rear side relative to the rear air-conditioning within a rear trunk space. Because of this, it is easy for the electronic instruments to be accessed from the rearward side of the rear trunk. As a result, workability when performing maintenance on a vehicle may be improved.

A second aspect of the present disclosure is a method of controlling a cooling device for a vehicle electronic instrument, the cooling device including: a rear air-conditioning section that is provided in a rear trunk in a vehicle rear portion, that is configured to adjust a temperature of air, and that supplies air to a vehicle cabin interior; and an electronic instrument cooling duct that configures a cooling path in the rear air-conditioning section through which passes cooling air, one or more electronic instruments being disposed in the cooling path, the method including: determining whether or not cooling of the one or more electronic instruments is required; and in a case in which it is determined that cooling of the one or more electronic instruments is required, activating the rear air-conditioning section to supply an airflow through the electronic instrument cooling duct towards a side of the electronic instruments.

According to the controlling method of a cooling device for a vehicle electronic instrument of the second aspect, firstly, a determination is made as to whether or not cooling of electronic instruments is required. Next, if it is determined that cooling of electronic instruments is required, the rear air-conditioning section is operated, and an airflow is supplied through the electronic instrument cooling duct towards the electronic instruments side. As a result, the electronic instruments provided along this rear air-conditioning section are cooled by the airflow flowing through the electronic instrument cooling duct.

A third aspect of the present disclosure is a non-transitory storage medium storing a program executable by a computer to perform control processing of a cooling device for a vehicle electronic instrument, the cooling device including: a rear air-conditioning section that is provided in a rear trunk in a vehicle rear portion, that is configured to adjust a temperature of air, and that supplies air to a vehicle cabin interior; and an electronic instrument cooling duct that configures a cooling path in the rear air-conditioning section through which passes cooling air, one or more electronic instruments being disposed in the cooling path, the control processing including: determining whether or not cooling of the one or more electronic instruments is required, and in a case in which it is determined that cooling of the one or more electronic instruments is required, activating the rear air-conditioning section to supply an airflow through the electronic instrument cooling duct towards a side of the electronic instruments.

According to the third aspect, as a result of executing the program, the electronic instruments provided along the rear air-conditioning section are cooled by the airflow flowing through the electronic instrument cooling duct.

According to the cooling device for vehicle electronic instruments, the controlling method of a cooling device for vehicle electronic instruments, and the storage medium for a controlling program for a cooling device for vehicle electronic instruments of the present disclosure, it is possible to cool electronic instruments even in a case in which it is not possible for these electronic instruments to be disposed inside a pillar or adjacent to the dashboard.

### BRIEF DESCRIPTION OF THE DRAWINGS

Exemplary embodiments of the present disclosure will be described in detail based on the following figures, wherein:

FIG. 1 is a plan view schematically illustrating a vehicle provided with a cooling device for electronic instruments for a vehicle of the exemplary embodiment;

FIG. 2 is a block diagram schematically illustrating a first ECU and a second ECU and the like;

FIG. 3 is a block diagram schematically illustrating a rear air-conditioner ECU and the like;

FIG. 4 is a flowchart illustrating a control flow of a rear air-conditioner and the like performed by the rear air-conditioner ECU;

FIG. 5 is a flowchart illustrating a control flow of the rear air-conditioner and the like performed by the rear air-conditioner ECU;

FIG. 6 is a plan view as seen from a vehicle upper side illustrating the rear air-conditioner, an electronic instrument cooling duct, the first ECU, and the second ECU and the like;

FIG. 7 is a bottom view as seen from a vehicle upper side illustrating the rear air-conditioner, the electronic instrument cooling duct, the first ECU, and the second ECU and the like;

FIG. 8 is a side view as seen from a vehicle right side illustrating the rear air-conditioner, the electronic instrument cooling duct, the first ECU, and the second ECU and the like;

FIG. 9 is a cross-sectional view taken across a line 9-9 illustrated in FIG. 6 schematically illustrating the first ECU and the electronic instrument cooling duct;

FIG. 10 is a perspective view illustrating a front-side bracket that supports the first ECU, the second ECU, and portions on a vehicle front-side of the electronic instrument cooling duct on a vehicle body; and

FIG. 11 is a perspective view illustrating the front-side bracket that supports the first ECU, the second ECU, and the portions on the vehicle rear-side of the electronic instrument cooling duct on the vehicle body.

### DETAILED DESCRIPTION

(Structure of the Cooling Device for Vehicle Electronic Instruments of the Exemplary Embodiment)

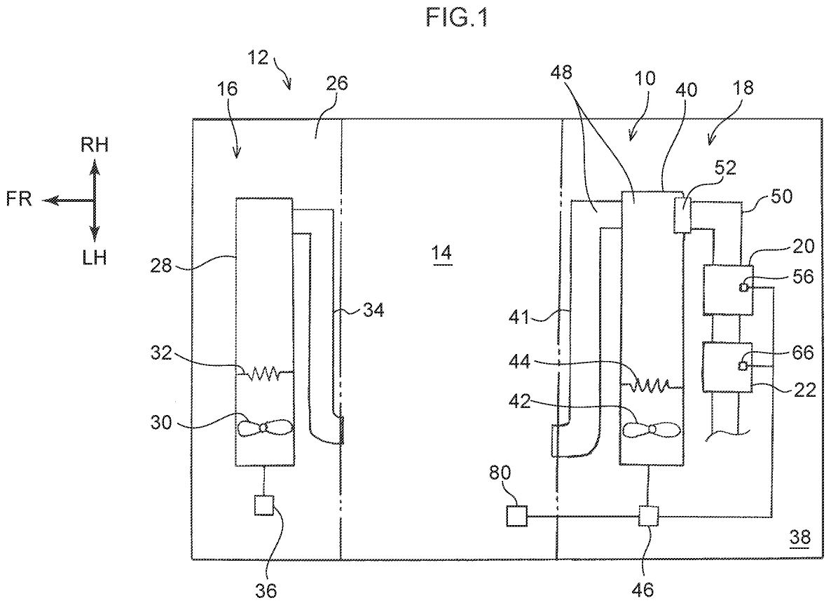

The structure of the cooling device for vehicle electronic instruments of the exemplary embodiment will now be described using FIG. 1 through FIG. 3. Note that, in the following description, unless specifically stated otherwise, front-rear, up-down, or left-right directions used in the following description refer respectively to the front-rear directions, the vertical direction, and the left-right directions of the vehicle. Moreover, an arrow FR, an arrow UP, an arrow RH, and an arrow LH that are illustrated in the drawings respectively indicate a forward direction, an upward direction, a right-side direction, and a left-side direction of the vehicle.

As illustrated in FIG. 1, a vehicle 12 provided with a cooling device 10 for vehicle electronic instruments of the exemplary embodiment is a self-driving vehicle that is capable of traveling autonomously without being driven by a person. The vehicle 12 is provided with a cabin 14 that serves as a vehicle cabin and is provided with seats and the like for vehicle occupants to sit on. In addition, the vehicle 12 is provided with a front air-conditioner 16 that is provided at a front side of the cabin 14, and a rear air-conditioner 18 that serves as a rear air-conditioning section and is provided at a rear side of the cabin 14. The vehicle 12 is additionally provided with a first ECU 20 and a second ECU 22 that serve as electronic instruments that are used to autonomously drive the vehicle 12, and with an ECU cooling duct 50 that serves as an electronic instrument cooling duct and enables an airflow from the rear air-conditioner 18 to flow towards the first ECU 20 and the second ECU 22.

The front air-conditioner 16 is disposed within a dashboard 26 at a front side of the cabin 14. The front air-conditioner 16 is provided with a housing 28 that is formed in a box shape, a fan 30 and a heat exchanger 32 that are disposed within the housing 28, and a duct 34 that is connected to the housing 28. Operations of a compressor (not illustrated in the drawings), which is connected to the fan 30 and the heat exchanger 32, are controlled by a front air-conditioner ECU 36. As a result of operations of the fan 30 and the compressor being controlled by the front air-conditioner ECU 36, air whose temperature has been adjusted within the housing 28 is supplied to the cabin 14 via the duct 34.

The rear air-conditioner 18 is disposed within a rear trunk 38 at the rear side of the cabin 14. Note that luggage is loaded into the rear trunk 38 from the vehicle rear side. The rear air-conditioner 18 is supported on the vehicle body while being disposed on the front side and upper side of the rear trunk 38. The rear air-conditioner 18 is provided with a housing 40 that is formed in a box shape, a fan 42 and a heat exchanger 44 that are disposed within the housing 40, and ducts 41 that are connected to the housing 40. Operations of a compressor (not illustrated in the drawings), which is connected to the fan 42 and the heat exchanger 44, are controlled by a rear air-conditioner ECU 46. Note that it is also possible for the rear air-conditioner ECU 46 to be formed integrally with the front air-conditioner ECU 36. As a result of operations of the fan 42 and the compressor being controlled by the rear air-conditioner ECU 46, air whose temperature has been adjusted within the housing 40 is supplied to the cabin 14 via the ducts 41. Here, the housing 40 and the ducts 41 form part of a main flow portion 48 through which air flows towards the cabin 14.

The ECU cooling duct 50 is disposed, together with the rear air-conditioner 18, within the rear trunk 38. The ECU cooling duct 50 is formed, as an example, in a cylindrical shape. Moreover, the ECU cooling duct 50 extends along the housing 40 at the rear side of the rear air-conditioner 18. An end portion on one side of the ECU cooling duct 50 is connected to the housing 40, while an end portion (not illustrated in the drawings) on another side of the ECU cooling duct 50 opens toward the cabin 14. Furthermore, a valve 52 that selectively blocks or allows the airflow from the housing 40 side, which is the main flow portion 48 side, towards the ECU cooling duct 50 side is provided at a boundary between the end portion on the one side of the ECU cooling duct 50 and the housing 40. As a result of operations of the fan 42 and the compressor being controlled by the rear air-conditioner ECU 46, and of the valve 52 being controlled by the rear air-conditioner ECU 46, air whose temperature has been adjusted within the housing 40 may be supplied to the ECU cooling duct 50 side.

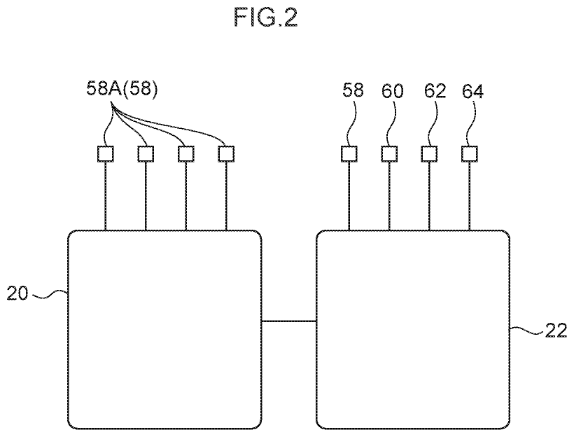

As illustrated in FIG. 1 and FIG. 2, the first ECU 20, which serves as a first electronic instrument, and the second ECU 22, which serves as a second electronic instrument, are disposed alongside the housing 40 at the rear side of the rear air-conditioner 18 and adjacent to each other in the left-right direction. In addition, the first ECU 20 and the second ECU 22 are supported on the vehicle body in a state in which a majority portion thereof is disposed along the upper side of the ECU cooling duct 50. The first ECU 20, which serves as a first electronic instrument, acquires and performs processing on information pertaining to at least the periphery of the vehicle 12. Various types of sensors 54 such as cameras 54A that are used to acquire the information pertaining to the periphery of the vehicle are connected to the first ECU 20. By processing the information such as images and the like obtained from the various types of sensors 54 such as the plurality of cameras 54A provided in the vehicle 12, the first ECU 20 estimates and determines a peripheral situation around the vehicle 12. Moreover, a portion of the first ECU 20 is disposed inside the ECU cooling duct 50 as a result of the portion of the first ECU 20 being inserted into an aperture (not illustrated in the drawings) formed in the ECU cooling duct 50. Furthermore, the portion of the first ECU 20 that is disposed inside the ECU cooling duct 50 is disposed on the side where the valve 52 is provided relative to a portion of the second ECU 22 that is disposed inside the ECU cooling duct 50 (described below). In other words, the portion of the first ECU 20 that is disposed inside the ECU cooling duct 50 is disposed on the upstream side of the airflow inside the ECU cooling duct 50 relative to the portion of the second ECU 22 that is disposed inside the ECU cooling duct 50 (described below). A temperature sensor 56 is provided in the first ECU 20. A temperature of a portion of the elements forming the first ECU 20 may be measured by this temperature sensor 56.

The second ECU 22 controls at least the driving of the vehicle 12. Various types of actuators 58, 60, 62, and 64 that are used to perform a steering wheel operation, an accelerator operation, a brake operation, and a gearshift operation and the like of the vehicle 12 are connected to the second ECU 22. In addition, the second ECU 22 and the first ECU 20 are mutually connected so as to be able to communicate with each other. The second ECU 22 controls the driving of the vehicle 12 by operating the various actuators 58, 60, 62, and 64 based on the peripheral situation around the vehicle 12 as determined by the first ECU 20. Moreover, the second ECU 20 is disposed inside the ECU cooling duct 50 as a result of a portion of the second ECU 22 being inserted into an aperture (not illustrated in the drawings) formed in the ECU cooling duct 50. A temperature sensor 66 is provided in the second ECU 22. A temperature of a portion of the elements forming the second ECU 22 may be measured by this temperature sensor 66.

Here, the first ECU 20 and the second ECU 22 are provided with structure and programs that are used in the event of a failure. As a consequence, even if the first ECU 20 fails, control of the driving of the vehicle 12 is able to be continued for at least a predetermined time by the second ECU 22. Similarly, even if the second ECU 22 fails, control of the driving of the vehicle 12 is able to be continued for at least a predetermined time by the first ECU 20. Note that, as an example, this predetermined time may be the time required to stop the vehicle 12 in a safe location after the failure of the first ECU 20 or the second ECU 22, or may be the time required for an occupant of the vehicle 12 to take over manual driving operations of the vehicle 12.

In addition, the first ECU 20 includes elements having lower heat-resistance temperatures than those in the second ECU 22. In other words, the second ECU 22 includes elements having higher heat-resistance temperatures than those in the first ECU 20. Note that, as an example, the elements whose heat-resistance temperatures are to be compared in the first ECU 20 and the second ECU 22 are elements whose temperature is measured by the temperature sensors 56 and 66.

As illustrated in FIG. 1 through FIG. 3, the cooling device 10 for vehicle electronic instruments of the exemplary embodiment is intended to cool the first ECU 20 and the second ECU 22. Note that, in the following description, the ‘cooling device 10 for vehicle’ electronic instruments' is referred to simply as the ‘cooling device 10’. This cooling device 10 includes the rear air-conditioner 18, the ECU cooling duct 50, and the rear air-conditioner ECU 46 as principal elements thereof.

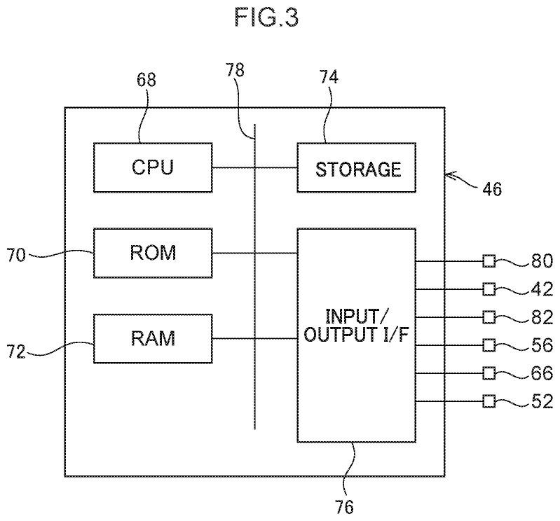

As illustrated in FIG. 3, the rear air-conditioner CPU 46 has a Central Processing Unit (CPU) 68, i.e., a processor, a Read Only Memory (ROM) 70, a Random Access Memory (RAM) 72, storage 74, and an input/output interface (I/F) 76 that enables communication with external devices to be performed, and a structure is employed in which these portions are mutually connected so as to be able to communicate with each other via a bus 78. An operating portion 80, which is operated by a vehicle occupant, the fan 42, a compressor 82 of the rear air-conditioner 18, the temperature sensor 56, the temperature sensor 66, and the valve 52 and the like are electrically connected to the input/output interface 76. The CPU 68 is a central processing unit that controls the rear air-conditioner 18 and the like by executing various types of programs. In other words, based on signals from the temperature sensor 56 and the temperature sensor 66 and the like, the CPU 68 reads out control programs from the ROM 70 or the storage 74, and executes these control programs using the RAM 72 as a work area so as to control the fan 42, the rear air-conditioner 18, and the valve 52 and the like.

Next, a controlling method of the cooling device 10 using a control program for the cooling device 10 of the exemplary embodiment will be described.

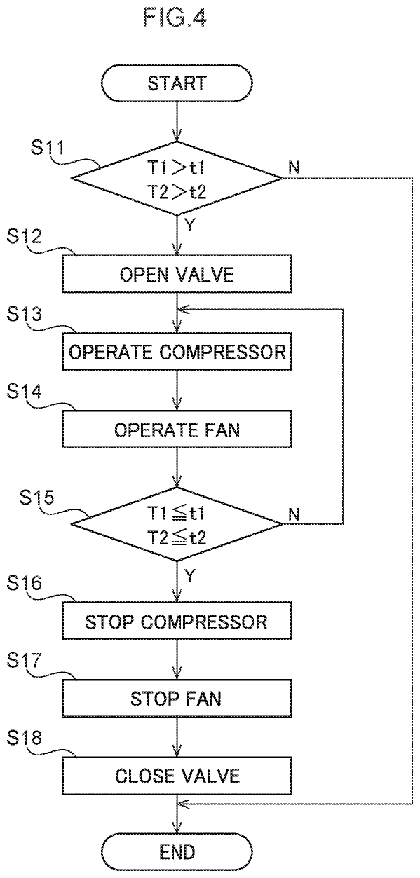

As illustrated in FIG. 4, in step S11, which serves as a step to determine whether or not cooling is necessary, based on signals from the temperature sensor 56 and the temperature sensor 66, the rear air-conditioner ECU 46 determines whether or not a temperature T1 of a portion of the elements forming part of the first ECU 20 exceeds a predetermined temperature t1, and also whether or not a temperature T2 of a portion of the elements forming part of the second ECU 22 exceeds a predetermined temperature t2. If the determination result in step S11 is negative, in other words, if it is determined that the temperature T1 of the portion of the elements forming part of the first ECU 20 does not exceed the predetermined temperature t1, and that the temperature T2 of the portion of the elements forming part of the second ECU 22 does not exceed the predetermined temperature t2, then the processing of the rear air-conditioner ECU 46 is ended. The rear air-conditioner ECU 46 then repeats the processing of step S11.

However, if the determination result in step S11 is affirmative, in other words, if it is determined that at least one of the temperature T1 of the portion of the elements forming part of the first ECU 20 exceeds the predetermined temperature t1 or the temperature T2 of the portion of the elements forming part of the second ECU 22 exceeds the predetermined temperature t2, then the rear air-conditioner ECU 46 performs the processing of step S12, step S13, and step S14, which serve as rear air-conditioning section operating steps. The rear air-conditioner ECU 46 opens the valve 52 in step S12. In addition, in step S13, the rear air-conditioner ECU 46 causes the compressor 82 to operate. Furthermore, in step S14, the rear air-conditioner ECU 46 causes the fan 42 to operate. As a result, air whose temperature has been adjusted within the housing 40 of the rear air-conditioner 18 is supplied to the ECU cooling duct 50 side, so that both the first ECU 20 and the second ECU 22 are cooled.

Next, in step S15, based on signals from the temperature sensor 56 and the temperature sensor 66, the rear air-conditioner ECU 46 determines whether or not the temperature T1 of the portion of the elements forming part of the first ECU 20 has dropped to less than the predetermined temperature t1, and also whether or not the temperature T2 of the portion of the elements forming part of the second ECU 22 has dropped to less than the predetermined temperature t2. If the determination result in step S15 is negative, in other words, if it is determined that at least one of the temperature T1 of the portion of the elements forming part of the first ECU 20 exceeds the predetermined temperature t1 or the temperature T2 of the portion of the elements forming part of the second ECU 22 exceeds the predetermined temperature t2, then the rear air-conditioner ECU 46 continues the processing of step S13 and step S14. Here, in the processing of step S13 and step S14, outputs from the compressor 82 and the fan 42 may be adjusted in accordance with the temperature T1 of the portion of the elements forming part of the first ECU 20 and the temperature T2 of the portion of the elements forming part of the second ECU 22. By employing this method, the first ECU 20 and the second ECU 22 may be cooled rapidly.

However, if the determination result in step S15 is affirmative, in other words, if it is determined that the temperature T1 of the portion of the elements forming part of the first ECU 20 has dropped to less than the predetermined temperature t1, and the temperature T2 of the portion of the elements forming part of the second ECU 22 has dropped to less than the predetermined temperature t2, then the rear air-conditioner ECU 46 performs the processing of step S16, step S17, and step S18. In step S16, the rear air-conditioner ECU 46 causes the compressor 82 to stop. In step S17, the rear air-conditioner ECU 46 causes the fan 42 to stop. Moreover, in step S18, the rear air-conditioner ECU 46 causes the valve 52 to close. The rear air-conditioner ECU 46 then ends the processing.

Next, a description will be given of a controlling method of the cooling device 10 in a case in which a vehicle occupant performs an operation to stop the rear air-conditioner 18 using the operating portion 80, while the processing of step S13 through step S15 illustrated in FIG. 4 is being performed.

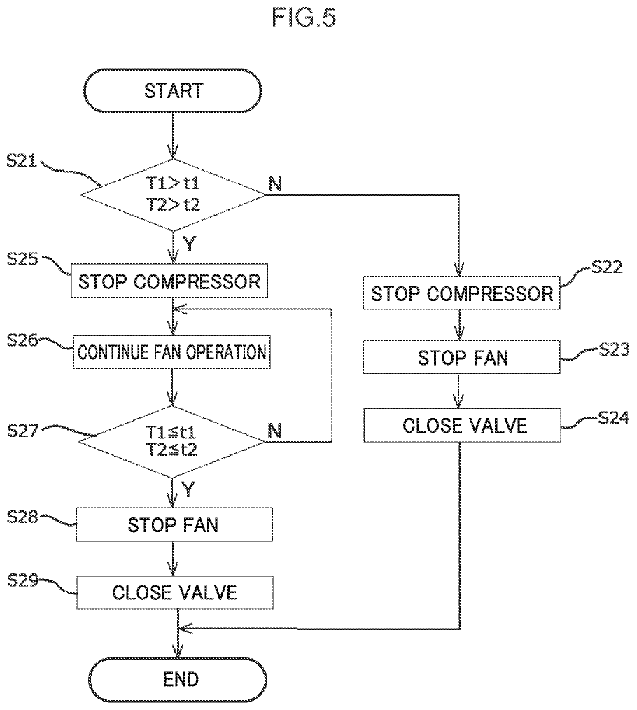

As illustrated in FIG. 5, in a case in which a vehicle occupant performs an operation to stop the rear air-conditioner 18 using the operating portion 80, while the processing of step S13 through step S15 illustrated in FIG. 4 is being performed, in step S21, based on signals from the temperature sensor 56 and the temperature sensor 66, the rear air-conditioner ECU 46 determines whether or not the temperature T1 of the portion of the elements forming part of the first ECU 20 exceeds the predetermined temperature t1, and also whether or not the temperature T2 of the portion of the elements forming part of the second ECU 22 exceeds the predetermined temperature t2. If the determination result in step S21 is negative, in other words, if it is determined that the temperature T1 of the portion of the elements forming part of the first ECU 20 does not exceed the predetermined temperature t1, and that the temperature T2 of the portion of the elements forming part of the second ECU 22 does not exceed the predetermined temperature t2, then the rear air-conditioner ECU 46 performs the processing of step S22, step S23, and step S24. In step S22, the rear air-conditioner ECU 46 causes the compressor 82 to stop. In step S23, the rear air-conditioner ECU 46 causes the fan 42 to stop. Furthermore, in step S24, the rear air-conditioner ECU 46 causes the valve 52 to close. The rear air-conditioner ECU 46 then ends the processing.

However, if the determination result in step S21 is affirmative, in other words, if it is determined that at least one of the temperature T1 of the portion of the elements forming part of the first ECU 20 exceeds the predetermined temperature t1 or the temperature T2 of the portion of the elements forming part of the second ECU 22 exceeds the predetermined temperature t2, then the rear air-conditioner ECU 46 performs the processing of step S25 and step S26. In step S25, the rear air-conditioner ECU 46 causes compressor 82 to stop operating. Furthermore, in step S26, the rear air-conditioner ECU 46 causes the fan 42 to continue operating. As a result, the cooling of the first ECU 20 and the second ECU 22 by the airflow from the rear air-conditioner 18 is continued. Here, in step S26, operations of the fan 42 are continued at a lower output than the output before the operation to stop the rear air-conditioner 18 is performed by the vehicle occupant.

Next, in step S27, based on signals from the temperature sensor 56 and the temperature sensor 66, the rear air-conditioner ECU 46 determines whether or not the temperature T1 of the portion of the elements forming part of the first ECU 20 has dropped to less than the predetermined temperature t1, and also whether or not the temperature T2 of the portion of the elements forming part of the second ECU 22 has dropped to less than the predetermined temperature t2. If the determination result in step S21 is negative, in other words, if it is determined that at least one of the temperature T1 of the portion of the elements forming part of the first ECU 20 exceeds the predetermined temperature t1 or the temperature T2 of the portion of the elements forming part of the second ECU 22 exceeds the predetermined temperature t2, then the rear air-conditioner ECU 46 continues the processing of step S26.

However, if the determination result in step S27 is affirmative, in other words, if it is determined that the temperature T1 of the portion of the elements forming part of the first ECU 20 has dropped to less than the predetermined temperature t1, and the temperature T2 of the portion of the elements forming part of the second ECU 22 has dropped to less than the predetermined temperature t2, then the rear air-conditioner ECU 46 performs the processing of step S28 and step S29. In step S28, the rear air-conditioner ECU 46 causes the fan 42 to stop. Moreover, in step S29, the rear air-conditioner ECU 46 causes the valve 52 to close. The rear air-conditioner ECU 46 then ends the processing.

(Operations and Effects of the Exemplary Embodiment)

Next, operations and effects of the exemplary embodiment will be described.

As illustrated in FIG. 1 through FIG. 3, according to the cooling device 10 of the exemplary embodiment, it is possible to cool the first ECU 20 and the second ECU 22 whose shape and size make it difficult for them to be located inside a pillar or in the vicinity of the dashboard 26.

Moreover, in the exemplary embodiment, the portion of the first ECU 20 that is disposed inside the ECU cooling duct 50 is disposed at the upstream side of the airflow inside the ECU cooling duct 50 relative to the portion of the second ECU 22 that is disposed inside the ECU cooling duct 50. Because of this, the airflow within the ECU cooling duct 50 may be supplied to the first ECU 20 before it is supplied to the second ECU 22. As a result, preference may be given to cooling the first ECU 20, which includes elements whose heat resistance temperature is lower than those in the second ECU 22. Because of this, it is possible to inhibit failures caused by the first ECU 20 overheating, and it is possible to appropriately cool the second ECU 22, which includes elements whose heat resistance temperature is higher than those in the first ECU 20. Moreover, in the exemplary embodiment, even if one of the first ECU 20 or the second ECU 22 were to fail, the other one of the first ECU 20 or the second ECU 22 is able to continue to control the driving of the vehicle 12 for at least a predetermined period of time.

Moreover, in the exemplary embodiment, the rear air-conditioner 18 is controlled based on the temperature of elements of the first ECU 20 and of elements of the second ECU 22 as measured by the temperature sensors 56 and 66. Because of this, the first ECU 20 and the second ECU 22 may be appropriately cooled in accordance with the temperature of the elements of the first ECU 20 and the elements of the second ECU 22.

Moreover, in the exemplary embodiment, the air supply from the rear air-conditioner 18 may be continued after an operation to stop the rear air-conditioner 18 has been performed by an occupant of the vehicle 12. Because of this, the first ECU 20 and the second ECU 22 may still be cooled regardless of whether or not an operation to stop the rear air-conditioner 18 has been performed by a vehicle occupant. In addition to this, in the exemplary embodiment, an operation of the fan 42 is continued at a lower output that the output before an operation to stop the rear air-conditioner 18 has been performed by a vehicle occupant. Because of this, it is possible to reduce a level of noise caused by an operation of the rear air-conditioner 18 after an operation to stop the rear air-conditioner 18 has been performed by a vehicle occupant.

In addition, in the exemplary embodiment, there is provided the valve 52 that selectively blocks or allows the airflow from the housing 40 side, which is the main flow portion 48 side of the rear air-conditioner 18, towards the ECU cooling duct 50 side. Because of this, in a case in which it is not necessary for the first ECU 20 and the second ECU 22 to be cooled by the rear air-conditioner 18, it is possible to inhibit a decrease in the flow rate of the airflow inside the main flow portion 48.

Moreover, in the exemplary embodiment, the first ECU 20 and the second ECU 22 are disposed at the vehicle rear side relative to the rear air-conditioner 18 within the rear trunk 38. Because of this, it is easy for the first ECU 20 and the second ECU 22 to be accessed from the rearward side of the rear trunk 38. As a result, workability when performing maintenance on the vehicle 12 may be improved.

(Specific Structure of the Rear Air-Conditioner 18 and the like)

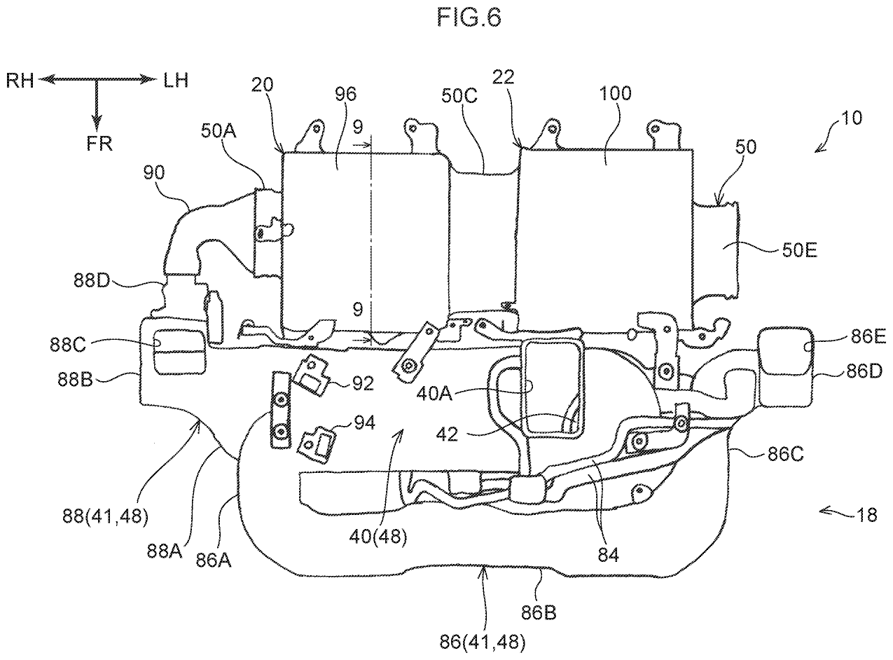

In the above description, a simplified description is given of the structures of the rear air-conditioner 18, the ECU cooling duct 50, the first ECU 20, and the second ECU 22. Hereinafter, a description will given of the specific structures of the rear air-conditioner 18, the ECU cooling duct 50, the first ECU 20, and the second ECU 22 using FIG. 6 through FIG. 9. Note that, portions in the following description that have already been described above may be omitted. Moreover, the structures described using FIG. 6 through FIG. 9 are provided with all of the structures described using FIG. 1 through FIG. 5.

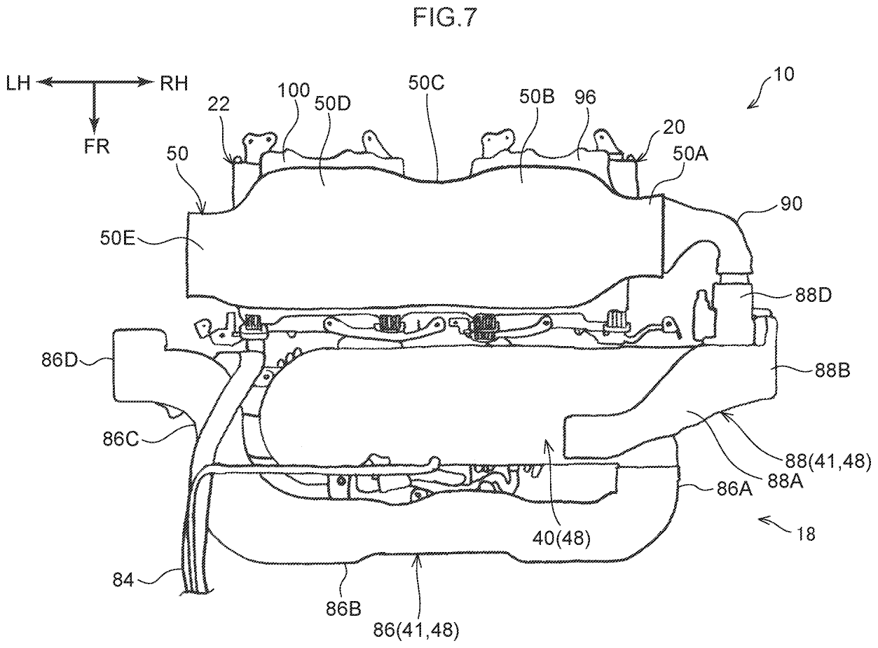

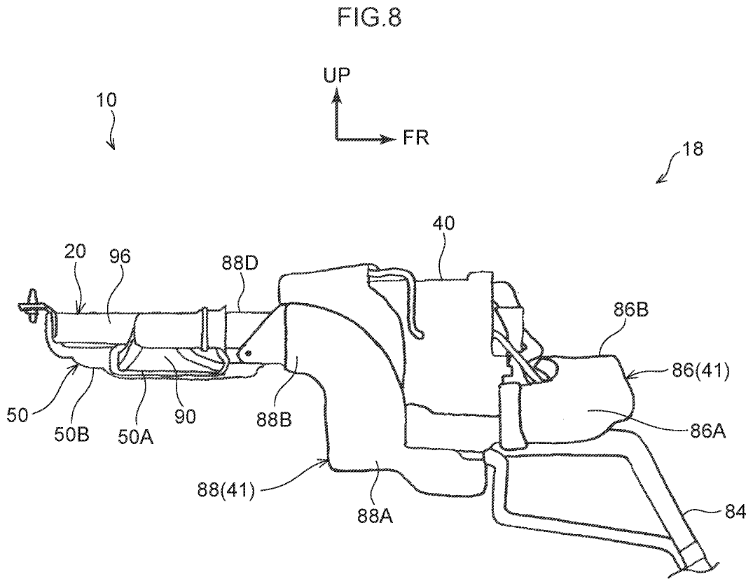

As illustrated in FIG. 6, FIG. 7, and FIG. 8, the rear air-conditioner 18 is provided with the housing 40 that is formed in a rectangular parallelepiped-box shape whose longitudinal direction extends in the left-right direction. As illustrated in FIG. 6, an air intake hole 40A, which is open at the upper side thereof, is formed in a left side of the housing 40. In addition, the fan 42 is disposed in a location adjacent to the air intake hole 40A in the housing 40. The heat exchanger 44 (see FIG. 1) is disposed within the housing 40. Pipes 84 that are connected to this heat exchanger 44 extend to the outside of the housing 40. Plural ducts 41 (86, 88) are connected to the housing 40. Note that the housing 40 and the plural ducts 41 (86, 88) form the main flow portion 48.

The first duct 86 is connected to the upper side of a right-side end portion of the housing 40. This duct 86 includes a first duct portion 86A that extends from the right-side end portion of the housing 40 in a downward direction, and a second duct portion 86B that extends from a front end of the first duct portion 86A towards the left side. In addition, this duct 86 includes a third duct portion 86C that extends from the left-side end of the second duct portion 86B towards the rear, and a fourth duct portion 86D that extends from a rear end of the third duct portion 86C towards the right side and upper side. The upper side of the fourth duct portion 86D forms a blower aperture 86E from which air flowing through the duct 86 is blown out. Note that a portion of the pipes 84 is disposed between the second duct portion 86B and the housing 40.

As illustrated in FIG. 7, the second duct 34 is connected to a lower side of a right-side end portion of the housing 40. This duct 34 includes a first duct portion 88A that extends from the right-side end portion of the housing 40 towards the right side, and a second duct portion 88B that extends from the right end of the first duct portion 88A towards the upper side. As illustrated in FIG. 6, the upper side of the second duct portion 88B forms a blower aperture 88C from which air flowing through the duct 34 is blown out. In addition, the duct 88 includes a cylindrical connecting portion 88D that communicates with a space inside the second duct portion 88B and protrudes from the second duct portion 88B towards the rear side. The ECU cooling duct 50 (described below) is connected to the connecting portion 88D via a connecting pipe 90 that is formed in an L shape.

The valve 52 (see FIG. 1) that selectively blocks or allows the airflow from the housing 40 side towards the duct 34 side is provided within the housing 40. This valve 52 is operated by an actuator 92. A valve (not illustrated in the drawings) that selectively blocks or allows the airflow from the housing 40 side towards the duct 86 side is also provided within the housing 40. This valve is also operated by the actuator 92.

As illustrated in FIG. 6, FIG. 7, and FIG. 8, the ECU cooling duct 50 is formed in a rectangular parallelepiped-box shape whose longitudinal direction extends in the left-right direction. More specifically, the ECU cooling duct 50 is formed in a box shape whose dimension in the vertical direction is set smaller than the dimensions thereof in the front-rear direction and left-right direction.

As illustrated in FIG. 7, the ECU cooling duct 50 includes a cylindrical first flow path portion 50A that is connected to the connecting pipe 90, and a cylindrical second flow path portion 50B that is disposed at the left side of the first flow path portion 50A and communicates with the first flow path portion 50A. In addition, the ECU cooling duct 50 includes a cylindrical third flow path portion 50C that is disposed at the left side of the second flow path portion 50B and communicates with the second flow path portion 50B, and a cylindrical fourth flow path portion 50D that is disposed at the left side of the third flow path portion 50C and communicates with the third flow path portion 50C. Furthermore, the ECU cooling duct 50 also includes a cylindrical fifth flow path portion 50E that is disposed at the left side of the fourth flow path portion 50D and communicates with the fourth flow path portion 50D.

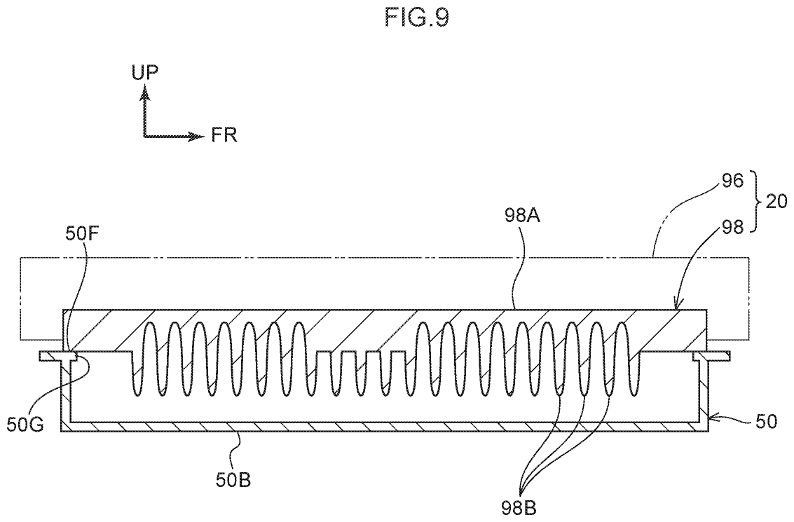

As illustrated in FIG. 9, a portion at the upper side of the second flow path portion 50B forms an ECU engagement portion 50F where the first ECU 20 is engaged. An aperture 50G that is formed in a rectangular shape when seen from above is formed in the ECU engagement portion 50F. In a state in which the first ECU 20 is engaged with the ECU engagement portion 50F, only fins 98B of a heat discharge portion 98 of the first ECU 20 (described below) are disposed within the second flow path portion 50B via the aperture 50G.

Note that, although not illustrated in the drawings, the fourth flow path portion SOD has the same structure as the second flow path portion 50B. Because of this, in a state in which the second ECU 22 is engaged with the ECU engagement portion of the fourth flow path 50D, only fins of a heat discharge portion of the second ECU 22 are disposed within the fourth flow path portion 50D via an aperture.

The first ECU 20 includes an ECU main body 96 that serves as an electronic instrument main body inside which there is housed a circuit board or the like on which are mounted circuit elements, and the heat discharge portion 98 that is formed integrally with the ECU main body 96. The heat discharge portion 98 includes a heat-receiving portion 98A that is in either direct contact or indirect contact with the circuit elements and the like, and the plural fins 98B that protrude from the heat-receiving portion 98A on the opposite side from the ECU main body 96 side, and are disposed at intervals from each other in the front-rear direction. Note that, although not illustrated in the drawings, the second ECU 22 has the same structure as the first ECU 20. In other words, the second ECU 22 includes an ECU main body 100 (see FIG. 6) that serves as an electronic instrument main body inside which there is housed a circuit board or the like on which are mounted circuit elements, and a heat discharge portion that is formed integrally with the ECU main body 100 and has a heat-receiving portion and fins.

In the specific structure described above as well, as a result of the rear air-conditioner 18 and the valve 52 being controlled using the controlling method of the cooling device 10 by means of the above-described control program for the control device 10, it is possible to cool the first ECU 20 and the second ECU 22.

Moreover, in the specific structure described above, only the fins 98B of the heat discharge portion 98 of the first ECU 20 are disposed within the second flow path portion 50B of the ECU cooling duct 50, and only the fins of the heat discharge portion of the second ECU 22 are disposed within the fourth flow path portion 50D of the ECU cooling duct 50. Because of this, compared with a case in which the entire first ECU 20 and second ECU 22 are disposed inside the ECU cooling duct 50, it is possible to more effectively inhibit any increase in the size of the ECU cooling duct 50. As a consequence, the thickness of the ECU cooling duct 50 in the vertical direction may be reduced.

(Structure of Supporting Portion of the First ECU 20, Second ECU 22, and Electronic Instrument Cooling Duct 41)

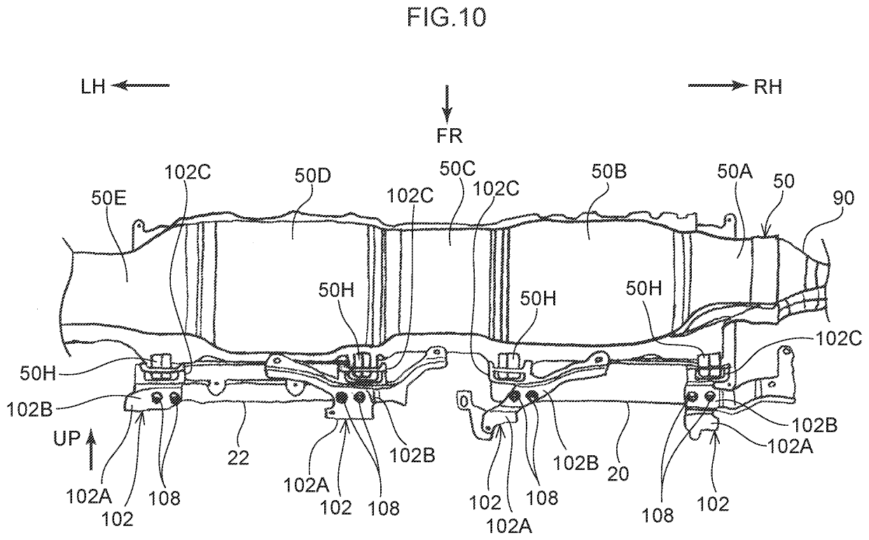

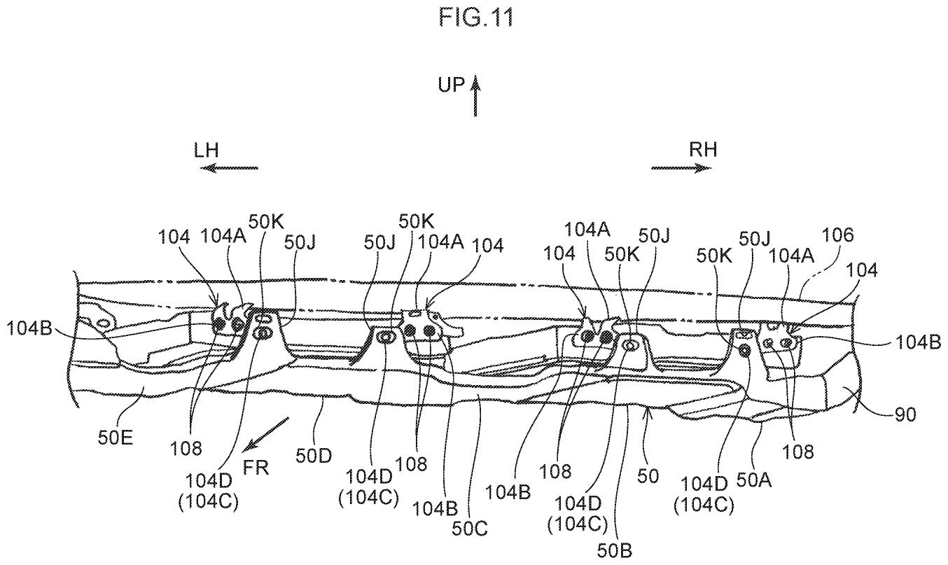

Next, a structure of a portion that supports the first ECU 20, the second ECU 22, and the electronic instrument cooling duct 41 on a vehicle body will be described using FIG. 10 and FIG. 11.

As illustrated in FIG. 10 and FIG. 11, the first ECU 20, the second ECU 22, and the electronic instrument cooling duct 41 are supported on an upper back panel 106, which serves as the vehicle body, via plural front-side brackets 102 and plural rear-side brackets 104, which serve as brackets. The upper back panel 106 forms a front side and upper side portion of the rear trunk 38, and forms a partition between the space inside the cabin 14 and the space inside the rear trunk 38 illustrated in FIG. 1. Note that, in FIG. 11, the upper back panel 106 is illustrated schematically by a double-dot chain line.

As illustrated in FIG. 10, the plural (here, four) front-side brackets 102 are formed by performing press-working or the like on a steel sheet material. Note that the shapes of the plural front-side brackets 102 are all mutually different from each other. In the following description, only the structures of the portions of each of the plural front-side brackets 102 that are necessary in order to support the first ECU 20, the second ECU 22, and the electronic instrument cooling duct 41 on the upper back panel 106 are described. The front-side brackets 102 are provided with a vehicle body joining portion 102A that is joined to the upper back panel 106, and an ECU fixing portion 102B that is disposed at the lower side of the vehicle body joining portion 102A and to which the first ECU 20 or the second ECU 22 is fixed via a fixing component 108 or the like. In addition, the front-side brackets 102 are disposed at the lower side of the ECU fixing portion 102B, and are provided with duct anchoring portions 102C to which front anchoring pieces 50H of the ECU cooling duct 50 (described below) are anchored.

The ECU cooling duct 50 is provided with plural front anchoring pieces 50H that are formed in a tongue shape that protrudes towards the front side. By inserting the plural front anchoring pieces 50H from the rear side respectively into the duct anchoring portions 102C of the plural front-side brackets 102, the plural front anchoring pieces 50H may be anchored respectively to the duct anchoring portions 102C of the plurality of front-side brackets 102.

As illustrated in FIG. 11, the plural (here, four) rear-side brackets 104 are formed by performing press-working or the like on a steel sheet material. Note that the shapes of the plural rear-side brackets 104 are all mutually different from each other. In the following description, only the structures of the portions of each of the plural rear-side brackets 104 that are necessary in order to support the first ECU 20, the second ECU 22, and the electronic instrument cooling duct 41 on the upper back panel 106 are described. The rear-side brackets 104 are provided with a vehicle body joining portion 104A that is joined to the upper back panel 106, and an ECU fixing portion 104B that is disposed at the lower side of the vehicle body joining portion 104A and to which the first ECU 20 or the second ECU 22 is fixed via a fixing component 108 or the like. In addition, the rear-side brackets 104 are disposed at the right side or the left side of the ECU fixing portion 104B, and are provided with duct anchoring portions 104C to which rear anchoring pieces 50J of the ECU cooling duct 50 (described below) are anchored. Clip insertion holes 104D into which clips (not illustrated in the drawings) are inserted are formed in the duct anchoring portions 104C.

The ECU cooling duct 50 is provided with plural rear anchoring pieces 50J that are formed in a tongue shape that protrudes towards the rear side and upper side. Clip insertion holes 50K into which clips (not illustrated in the drawings) are inserted are formed in the rear anchoring pieces 50J. In a state in which the plural rear anchoring pieces 50J have been disposed at the rear side of the duct anchoring portions 104C of the rear-side brackets 104, by then inserting clips (not illustrated in the drawings) into the clip insertion holes 104D of the duct anchoring portions 104C, and into the clip insertion holes 50K of the rear anchoring pieces 50J, the plural rear anchoring pieces 50J may be anchored respectively to the duct anchoring portions 104C of the plural rear-side brackets 104.

In the structure described above, the ECU cooling duct 50 and the first ECU 20 and second ECU 22 are supported on the upper back panel 106 via the same front-side brackets 102 and rear-side brackets 104. As a result, compared with a structure in which the ECU cooling duct 50 and the first ECU 20 and second ECU 22 are supported on the upper back panel 106 via mutually different brackets, it is possible to reduce disparities between the positions of the ECU cooling duct 50 and the first ECU 20 and second ECU 22.

Note that, in the above-described example, a description is given of a case in which the first ECU 20 and the second ECU 22 are cooled, however, the present disclosure is not limited to this. For example, a structure that cools a single ECU, or a structure that cools three or more ECU may also be employed. Furthermore, the electronic instrument serving as the object being cooled is not limited to being an ECU. For example, the object being cooled may also be another electronic instrument such as a converter or the like. Moreover, depending on the dimensions and the like of the electronic instrument serving as the object being cooled, it is also possible to employ a structure in which the entire electronic instrument is disposed within the electronic instrument cooling duct.

An exemplary embodiment of the present disclosure has been described above, however, the present disclosure is not limited to this. Various modifications and the like may be made to the present disclosure insofar as they do not depart from the spirit or scope of the present disclosure.

What is claimed is:

1. A cooling device for a vehicle electronic instrument, the cooling device comprising:
a rear air-conditioning section that is provided in a rear trunk at a vehicle rear portion, that is configured to adjust a temperature of air, and that supplies air to a vehicle cabin interior; and
an electronic instrument cooling duct that configures a cooling path in the rear air-conditioning section and through which passes cooling air, one or more electronic instruments being disposed in the cooling path.

2. The cooling device for a vehicle electronic instrument according to claim 1, wherein the electronic instrument includes:
a first electronic instrument that is disposed in the electronic instrument cooling duct and includes one or more elements therein; and
a second electronic instrument that is disposed at a downstream side in an air supply direction from the first electronic instrument and includes one or more elements having a higher heat resistance temperature than that of the one or more elements inside the first electronic instrument.

3. The cooling device for a vehicle electronic instrument according to claim 2, wherein the electronic instrument includes:
a first ECU that processes information on a vehicle periphery; and
a second ECU that is able to perform mutual communication with the first ECU and that controls driving of the vehicle, and
wherein, if one of the first ECU or the second ECU fails, the other of the first ECU or the second ECU continues to control the driving of the vehicle for at least a predetermined period of time.

4. The cooling device for a vehicle electronic instrument according to claim 1, further comprising:
a temperature sensor that measures a temperature of the electronic instruments; and
a processor that is configured to control the rear air-conditioning section based on a temperature measured by the temperature sensor.

5. The cooling device for a vehicle electronic instrument according to claim 4, wherein the processor is configured to continue operation of the rear air-conditioning section after an operation to stop the rear air-conditioning section has been performed by a vehicle occupant.

6. The cooling device for a vehicle electronic instrument according to claim 5, wherein the processor is configured to continue the operation of the rear air-conditioning section at a lower output than the output before the operation to stop the rear air-conditioning section has been performed by a vehicle occupant.

7. The cooling device for a vehicle electronic instrument according to claim 1, wherein the electronic instrument includes an electronic instrument main body and a heat discharge portion that is formed integrally with the electronic instrument main body, and
the electronic instrument main body is disposed outside of the electronic instrument cooling duct, while the heat discharge portion is disposed inside the electronic instrument cooling duct.

8. The cooling device for a vehicle electronic instrument according to claim 1, wherein the rear air-conditioning section comprises:
a main flow portion through which flows the airflow towards the vehicle cabin interior, and from which the electronic instrument cooling duct branches off; and
a valve that is provided at a boundary between the main flow portion and the electronic instrument cooling duct, and that selectively blocks or allows passage of the airflow from the main flow portion side towards the electronic instrument cooling duct side.

9. The cooling device for a vehicle electronic instrument according to claim 1, further comprising a bracket that supports the electronic instrument cooling duct and the electronic instruments at a vehicle body.

10. The cooling device for a vehicle electronic instrument according to claim 1, wherein:
the rear air-conditioning section and the electronic instrument are disposed within a rear trunk that is provided at a vehicle rear side of the vehicle cabin interior and into which luggage is able to be loaded from the vehicle rear side, and
the electronic instrument is disposed at the vehicle rear side relative to the rear air-conditioning section.

11. A method of controlling a cooling device for a vehicle electronic instrument, the cooling device including:
a rear air-conditioning section that is provided in a rear trunk in a vehicle rear portion, that is configured to adjust a temperature of air, and that supplies air to a vehicle cabin interior; and
an electronic instrument cooling duct that configures a cooling path in the rear air-conditioning section through which passes cooling air, one or more electronic instruments being disposed in the cooling path, the method comprising:
determining whether or not cooling of the one or more electronic instruments is required; and
in a case in which it is determined that cooling of the one or more electronic instruments is required, activating the rear air-conditioning section to supply an airflow through the electronic instrument cooling duct towards a side of the electronic instruments.

12. A non-transitory storage medium storing a program executable by a computer to perform control processing of a cooling device for a vehicle electronic instrument, the cooling device including:
a rear air-conditioning section that is provided in a rear trunk in a vehicle rear portion, that is configured to adjust a temperature of air, and that supplies air to a vehicle cabin interior; and
an electronic instrument cooling duct that configures a cooling path in the rear air-conditioning section through which passes cooling air, one or more electronic instruments being disposed in the cooling path, the control processing comprising:
determining whether or not cooling of the one or more electronic instruments is required, and
in a case in which it is determined that cooling of the one or more electronic instruments is required, activating the rear air-conditioning section to supply an airflow through the electronic instrument cooling duct towards a side of the electronic instruments.
